(19) United States
(12) Patent Application Publication
(10) Pub. No.: US 2008/0251503 A1
(43) Pub. Date: Oct. 16, 2008

(54) MODULAR PLASMA SPRAY GUN

(76) Inventor: Majed Noujaim, Manchester, CT (US)

Correspondence Address: MCCORMICK, PAULDING & HUBER LLP, CITY PLACE II, 185 ASYLUM STREET, HARTFORD, CT, 06103, US

(21) Appl. No.: 12/123,169

(22) Filed: May 19, 2008

Related U.S. Application Data
(63) Continuation-in-part of application No. 11/584,845, filed on Oct. 23, 2006, now Pat. No. 7,375,301.
(60) Provisional application No. 60/953,061, filed on Jul. 31, 2007.

(51) Int. Cl. H05H 1/32; B05B 15/00

(52) U.S. Cl. 219/121.47; 219/121.48

(57) ABSTRACT

The present invention provides a modular plasma spray gun including a sleeve, a core, and a water tube connectable to the sleeve. The sleeve has a cylindrical sidewall defining a central opening through a length thereof for receiving the core. The sleeve includes a mounting member for mounting the sleeve and an associated spray gun to a spray gun manipulator. The core receives an anode housing and is removably disposed in the central opening of the sleeve and includes forward and rearward portions defined by a stepped central bore through a length thereof. The forward portion receives an anode housing therein, the rearward portion for carrying coolant to and from the anode housing. The coolant inlet tube, coolant outlet tube, and gas inlet tube are manually detachable from an opening in the plasma spray gun assembly and have manually removable locks to prevent tube detachment.

### CROSS REFERENCE TO RELATED APPLICATIONS

This application is a continuation-in-part of pending U.S. patent application Ser. No. 11/584,845, filed Oct. 23, 2006, and U.S. Provisional Patent Application No. 60/953,061, filed Jul. 31, 2007, entitled “MODULAR ANODE SUPPORT MEMBER FOR PLASMA SPRAY GUN”. Applicant claims priority of the above-identified applications which are incorporated herein by reference in its entirety.

### FIELD OF THE INVENTION

The present invention generally relates to plasma spray guns which use an electric arc to excite a gas and produce a thermal plasma of very high temperatures, wherein coating materials are introduced into the thermal plasma, melted and projected onto a substrate to form a coating on the substrate. More particularly, the present invention is directed to an improved modular plasma spray gun including modular anode and cathode support members.

### BACKGROUND OF THE INVENTION

Generally, plasma spraying includes spraying of molten or heat softened material onto a substrate to provide a coating on the substrate. Typically, material in the form of powder is injected into a very high temperature plasma flame where it is rapidly heated and accelerated to a high velocity. The hot material, directed toward the substrate, impacts a surface of the substrate and rapidly cools forming a coating thereon.

A plasma spray gun usually includes a cathode and anode both of which are water-cooled. The anode is typically formed in the shape of a nozzle of the spray gun. An inert gas, such as argon, is directed around the cathode and through the nozzle. A plasma flame is initiated by a high voltage discharge which causes localized ionization and a conductive path for an arc to form between the cathode and anode. Resistance heating from the arc causes the gas to reach extreme temperatures and ionize forming a plasma flame directed through the nozzle. A coating material injected into the plasma flame is rapidly heated and accelerated toward a substrate to be coated. The heated material impacts the substrate where it rapidly cools forming a coating thereon.

Generally, a plasma spray gun using an inert gas such as argon can produce a thermal plasma of very high temperatures, up to 20,000 degrees Centigrade. Typically, the electrical current used to produce the arc between the cathode and anode is approximately 500 Amperes or more. Due to the high temperatures involved with the above-described plasma spray guns, a water cooling system is also provided for cooling both the anode and cathode and associated parts of the spray gun.

An F4 plasma spray gun manufactured by Sulzer Metco AG of Switzerland (herein referred to as the “F4 plasma spray gun” or the “F4 spray gun”) is widely used in the thermal spraying industry and has become one of the predominant plasma spray guns currently used. Referring to FIGS. 1-3, a prior art F4 plasma spray gun includes a rear section 1 for supporting an electrode 2 which provides the negative pole or cathode of the plasma gun. A center section 3 supports an anode holder 4 and includes a mount for attaching the spray gun to a manipulator. The anode holder 4 receives a water cooled nozzle 5 which forms the positive pole or anode for the electric arc. Referring to FIG. 2, the center section 3 of the F4 gun also includes a water coolant inlet tube 6 attached to a water tube block (not shown). As shown in FIG. 3, the rear section 1 includes a coolant outlet tube 7 connectable to a coolant return line (not shown).

Although not clearly shown in FIGS. 1 and 2, one of the drawbacks of the F4 spray gun is that major components of the spray gun, including the center and rear sections thereof, are made from multiple pieces of lightweight brass brazed together. Thus, if one component of the center or rear sections of the plasma gun becomes damaged or worn, the entire center section, or entire rear section of the gun must be replaced. Typically, these components are expensive pieces such that replacement thereof is costly and significantly adds to the operating costs of the F4 plasma gun.

Additionally, the manufacturing process for each of the center section 3 and rear section 1 of the F4 gun requires the brazing of multiple parts, one to the other, followed by pressure testing of the brazed joints. Thus, each of a multiplicity of parts is first finish-machined or otherwise formed prior to the assembly. Following assembly, the parts are brazed to form the final assembly. Thereafter, the finished products are tested, i.e., the brazed joints of the center and rear sections require testing (typically pressure testing) to confirm the integrity of the joints and the resulting seal formed between the brazed together parts. The brazed assembly is also dimensionally inspected to assure the components have not exceeded blueprint specifications as a result of the brazing process. Any parts that fail a pressure test or dimensional inspection are presumably scrapped or recycled, which further adds to the cost of the manufacturing process.

Normally, in the maintenance of the of the F4 spray gun, the gun is taken apart and inspected on a regular basis. The nozzle 5 and electrode 2 as well as O-rings 8 positioned between adjacent components are replaced periodically. If any portion of the center section 3 or rear section 1 is worn or otherwise damaged, the entire section must be replaced. Additionally, the center and/or rear sections of the F4 spray gun can also be damaged during disassembling and re-assembling of the spray gun, which also results in the replacement of the entire damaged section.

Another disadvantage of the center section 3 of the F4 plasma spray gun is that the water tube 6 at an end thereof is inserted into an opening in a water tube block and fluidly sealed thereto via a brazed joint. This brazed joint is somewhat fragile and susceptible to damage and/or leaks caused by twisting of the water tube during the coupling or uncoupling of a coolant source line to the water tube. Again, if the water tube is damaged or a leak occurs, the entire center section must be replaced prior to operating the spray gun.

A further disadvantage of the center section of the F4 plasma spray gun is the cost of replacement thereof. Due to the complex manufacturing process described above, the cost of the center section is relatively expensive and adds considerably to the cost of operating the spray gun especially since the functional life of the center section is relatively short due in part to the unitary design thereof.

Similarly, the rear section 1 of the F4 plasma spray gun is formed of multiple brazed-together parts wherein the assembled parts require pressure testing following assembly thereof. Further, the rear section of the F4 plasma spray gun includes a coolant outlet tube 7 and plasma gas inlet tube 9 brazed to a body portion of the rear section. Again, these type of brazed joints are fragile and susceptible to damage and/or leaks caused by twisting of the tubes during the coupling or uncoupling of the lines to an adjoining line. If either the coolant outlet tube 7 or the plasma gas inlet tube 9 is damaged or a leak occurs, the entire rear section 1 must be replaced prior to operating the spray gun.

Based on the foregoing, it is the general object of the present invention to provide an improved modular plasma spray gun that improves upon, or overcomes the problems and drawbacks associated with the prior art.

### SUMMARY OF THE INVENTION

The present invention provides a modular plasma spray gun including modular anode and cathode support members having removable coolant and plasma gas lines coupled thereto. Each of the multiple component parts of the plasma spray gun is separately replaceable such that one or more damaged or worn parts of the spray gun can be removed and replaced independent of the remaining component parts of the spray gun.

The modular anode support member includes a separable sleeve and core, and has a manually detachable coolant inlet tube coupled to the sleeve. An anode holder and anode or nozzle are coupled to the core of the anode support member, and are removably disposed in the support member. The anode support member includes an angular alignment element for establishing and fixing a predetermined angular alignment between the core and sleeve when assembled. The coolant inlet tube transports coolant from a coolant supply to the anode end of the plasma spray gun for cooling the anode and associated parts of the spray gun. Additionally, the coolant inlet tube carries an electrical current to the anode nozzle.

The modular cathode support member is coupled to the anode support member with an insulator section disposed therebetween for electrically separating the anode and cathode support members. The cathode support member carries an electrode removably coupled thereto. A manually detachable coolant outlet line and a manually detachable gas inlet line are coupled to the cathode support member. The coolant outlet line also carries electrical current to the cathode.

The plasma spray gun further includes an interlocking modular housing removably coupled to the cathode support member, the housing defining cavities for receiving the coolant inlet and outlet tubes and electrically separating one from the other. The housing includes two half sections, one defining a recess to accept a corresponding protrusion formed in the other half section.

One advantage of the present invention is that each of the component parts thereof is separable one from the other such that each component part is replaceable independent of the other components of the spray gun.

An advantage of the modular anode support member is that each component part thereof, including the core, the sleeve, and the coolant inlet tube is fabricated from a single piece of stock material such that the manufacture of the component parts as well as the assembled anode support member does not require any brazing or otherwise securing multiple parts together.

A further advantage of the present invention modular anode support member is that the configuration of the coolant passageways therein as well as the manufacturing processes required for the same provide a finished assembly that does not require any pressure testing following the manufacture of the component parts thereof nor of the assembled anode support member.

A still further advantage of the present invention anode support member is that the configuration of the sleeve, the core, and the manually detachable water tube provide a robust and durable support for the anode holder and an improvement over the prior art.

Similarly, the cathode support member including the coolant and gas passageways defined thereby is machined from a single piece of stock and therefore does not require pressure testing either at the individual component level or in assembly. Also, the coolant outlet line and gas inlet line are each formed from unitary pieces of raw material machined to define the fittings on the opposing ends of the lines and drilled to define the passageway therethrough, thus there are no joints between individual pieces and no testing of the parts is necessary except for spot checking the machined parts to confirm the conformance with any dimensional specifications.

A still further advantage of the present invention is that the interlocking modular housing encasing the electrode support member prevents the accumulation of plasma spray powder and formation of a short circuit between the positively charged coolant inlet tube and the negatively charged coolant outlet tube.

The foregoing and still other objects and advantages of the present invention will be more apparent from the following detailed explanation of the preferred embodiments of the invention in connection with the accompanying drawings wherein throughout the figures, like reference numerals describe like elements of the invention.

### BRIEF DESCRIPTION OF THE DRAWINGS

FIG. 1 is an exploded perspective view of a prior art F4 plasma spray gun.

FIG. 2 is a perspective view of a center section of the F4 plasma spray gun of FIG. 1.

FIG. 3 is a perspective view of a rear section of the F4 plasma spray gun of FIG. 1.

FIG. 4 is an exploded perspective view of one embodiment of a modular plasma spray gun in accordance with the present invention.

FIG. 5 is an exploded view of one embodiment of a modular anode support member in accordance with the present invention.

FIG. 6 is a perspective view of a sleeve of the anode support member of FIG. 5.

FIG. 7 is a cross-sectional view taken along line 7-7 of a core of the anode support member of FIG. 5.

FIG. 8 is perspective view of the core of the anode support member of FIG. 5.

FIG. 9 is an additional cross-sectional view taken along line 9-9 of the core of the anode support member of FIG. 5, including the anode holder.

FIG. 10 is a perspective view of one embodiment of the cathode support member of the present invention shown in assembly with associated components of the modular plasma spray gun of FIG. 4.

FIG. 11 is an exploded perspective view of the cathode support member of FIG. 10.

FIG. 12 is a perspective assembly view of the modular plasma spray gun of FIG. 4 shown without one half-section of the housing thereof.

FIG. 13 is a cross sectional view of the plasma spray gun of FIG. 12 taken at the line 13-13.

FIG. 14 is a top view of the cathode support member of FIG. 11.

FIG. 15 is a cross sectional view of the cathode support member of FIG. 14 taken at the line 15-15.

FIG. 16 is a cross sectional view of the cathode support member of FIG. 14 taken at the line 16-16.

FIG. 17 is a cross sectional view of the housing halves in spaced apart relationship of FIG. 4 at the section line 17-17 in FIG. 13.

FIG. 18 is a cross sectional view of the assembled housing halves of FIG. 17.

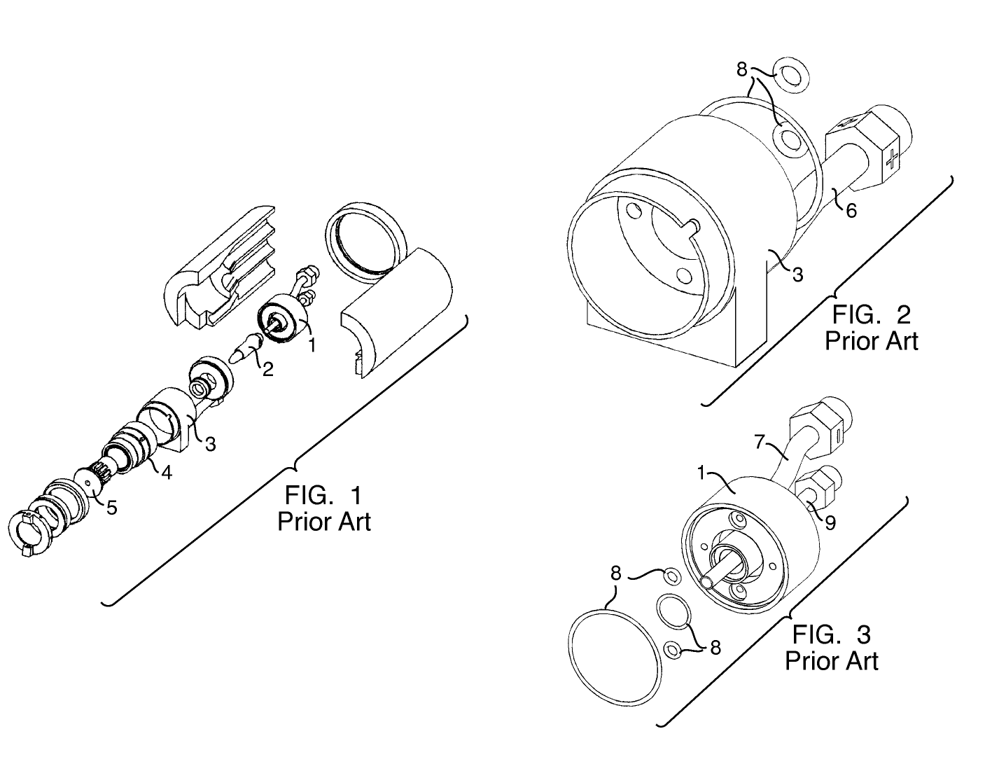

### DETAILED DESCRIPTION OF THE INVENTION

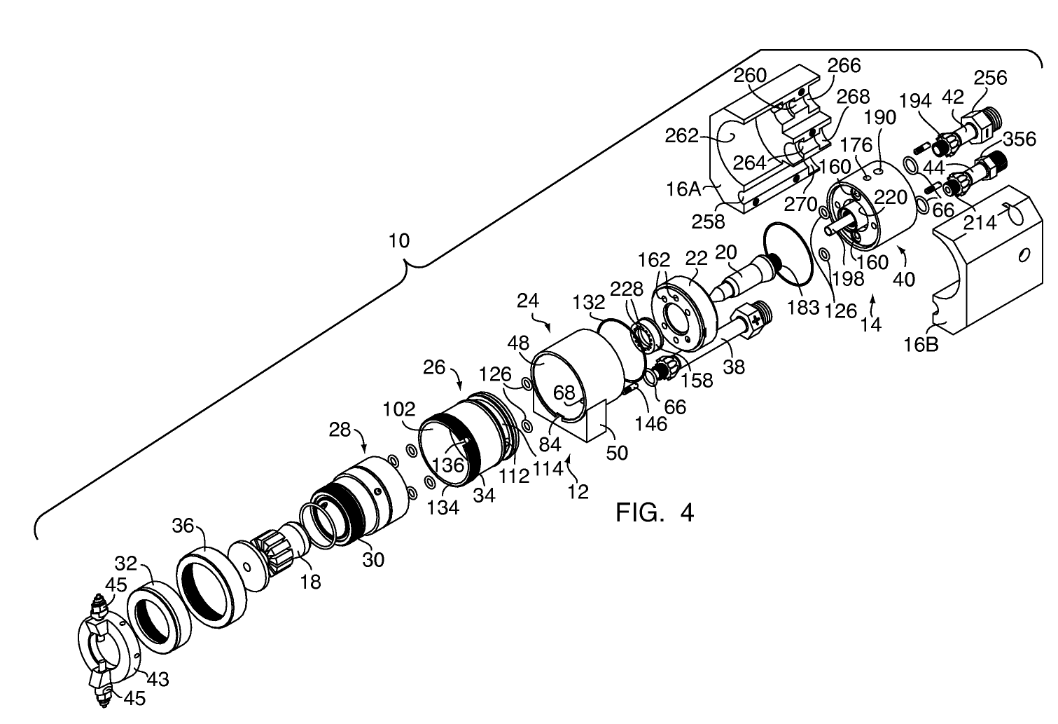

Referring to FIG. 4, the present invention modular plasma spray gun is generally referred to with the reference numeral 10. The plasma spray gun 10 includes a modular first electrode support member, generally 12, a second electrode support member, generally 14, and a housing 16, shown in two halves 16A and 16B. In the disclosed embodiment, the first electrode support member 12 is an anode support member and the second electrode support member 14 is a cathode support member.

The first electrode support member 12 carries a first electrode 18 of the plasma spray gun 10. In the disclosed embodiment, the first electrode is the anode electrode and also serves as the nozzle of the gun. A second electrode 20 is coupled to and supported by the second electrode support member 14, the second electrode 20 providing an oppositely charged cathode of the plasma spray gun 10 in the disclosed example. An insulator section 22 is disposed between the first electrode support member 12 and the second electrode support member 14.

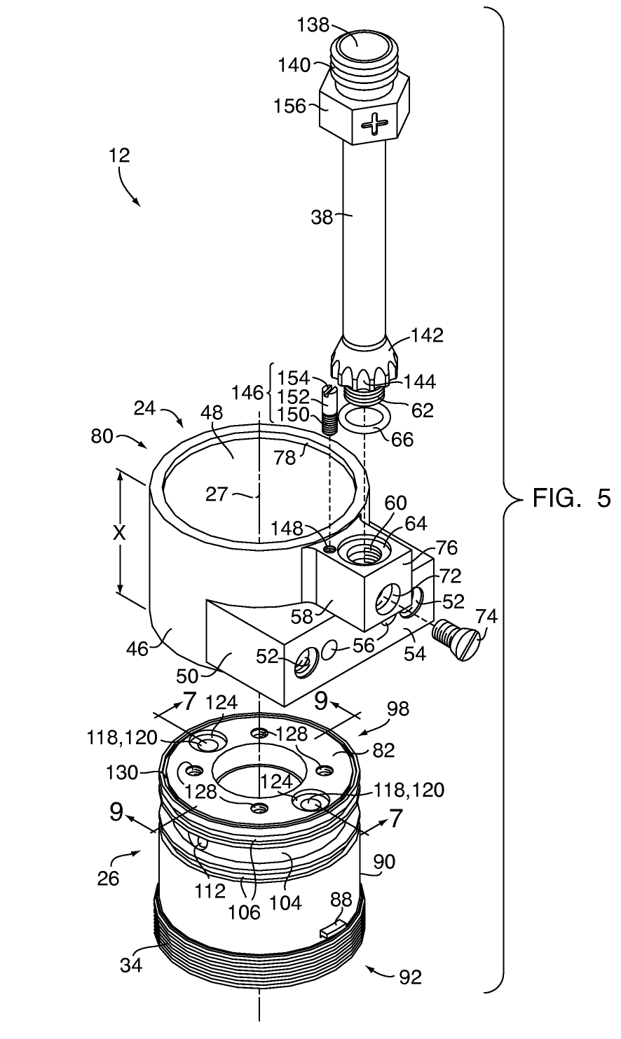

The first electrode support member 12 includes a sleeve 24 and a core 26 aligned with one another about an axis 27 (shown in FIG. 5). The first electrode support member 12 further includes an electrode holder 28 for supporting the nozzle 18. A threaded end 30 of the electrode holder 28 receives a retainer nut 32 for securing the nozzle 18 within the electrode holder 28. A threaded end 34 of the core 26 receives a retaining nut 36 for securing the electrode holder 28 within the core 26. A first water tube 38, for carrying water to the first electrode support member 12, connects to the sleeve 24. In the disclosed embodiment, the first water tube 38 is a water inlet tube. Although water is commonly used as the coolant, other forms of coolant may be used.

The second electrode support member 14 includes a body portion 40 that carries the second electrode 20 and is coupled to a second water tube 42 and a plasma gas inlet tube 44. In the disclosed embodiment, the second water tube 42 is a coolant outlet tube.

The plasma spray gun assembly 10 further includes a powder injector holder 43 mounted to the retainer nut 32. In the disclosed embodiment, two powder injectors 45 mount to the powder injector holder 43.

Referring to FIG. 5, the sleeve 24 of the first electrode support 12 includes a generally cylindrical sidewall 46, which defines a central opening 48 along the axis 27 through a length X of the sleeve. A mounting member 50 is formed integrally with the sidewall 46 and extends outwardly therefrom. The mounting member 50 defines a pair of threaded holes 52, 52 opening through a surface 54 of the mounting member opposite the sidewall 46 for receiving corresponding bolts for mounting the first electrode support member 12 and the plasma spray gun 10 to a spray gun manipulator (not shown). Additionally, the mounting member 50 defines a pair of smooth bore holes 56, 56 one each adjacent the threaded holes 52, 52 for use in aligning the mounting member relative to a corresponding spray gun mount on a spray gun manipulator. The smooth bore holes 56, 56 receive alignment pins (not shown) for aligning the mounting member 50 relative to a mating part. In one embodiment, the mounting member 50 is formed integrally with the sidewall 46 from a solid mass of material, preferably brass, such that the mounting member is durable and fixedly aligned with the sleeve 24 for accurately aligning the plasma spray gun 10 relative to a spray gun manipulator. Thus, regardless of the number of times the sleeve 24 and/or the associated spray gun 10 is removed or coupled to a spray gun manipulator, the mounting member 50 remains fixedly aligned with the sleeve 24.

In the illustrated embodiment, the sleeve 24 further defines a water tube mount 58 formed integrally with the sidewall 46 and extending outwardly therefrom. The water tube mount 58 defines a first fluid opening 60 for receiving an outlet end 62 of the first water tube 38. In the disclosed embodiment, the first fluid opening 60 is a threaded coolant inlet opening. An annular seat 64 surrounding the first fluid opening 60 receives a seal 66 for fluidly sealing a connection between the first water tube 38 and the first fluid opening 60.

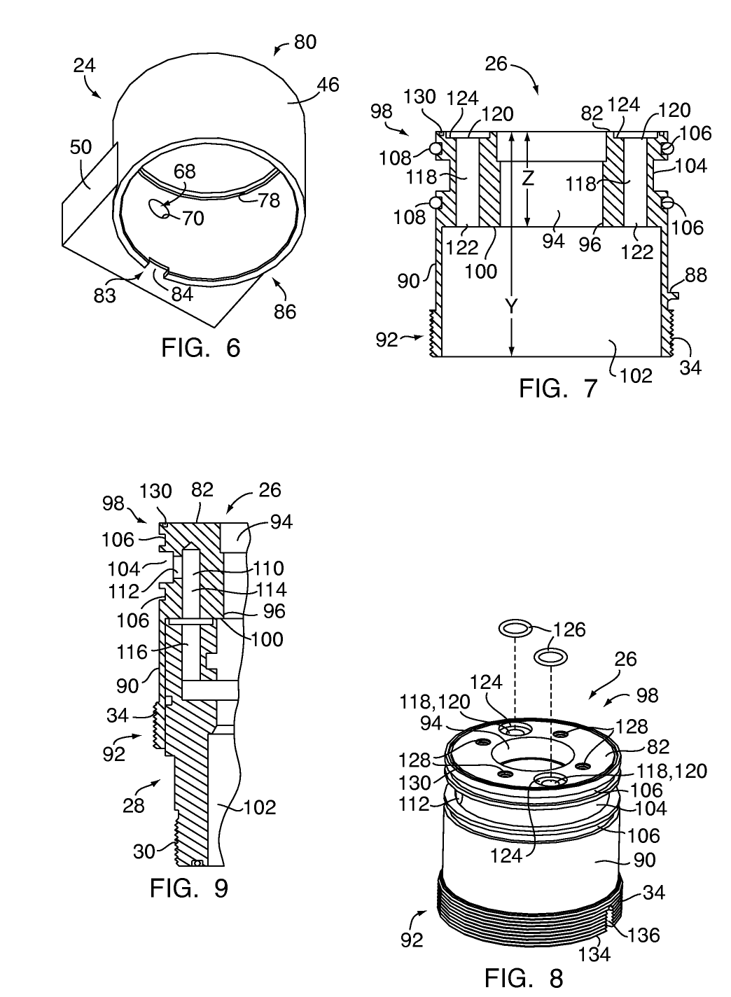

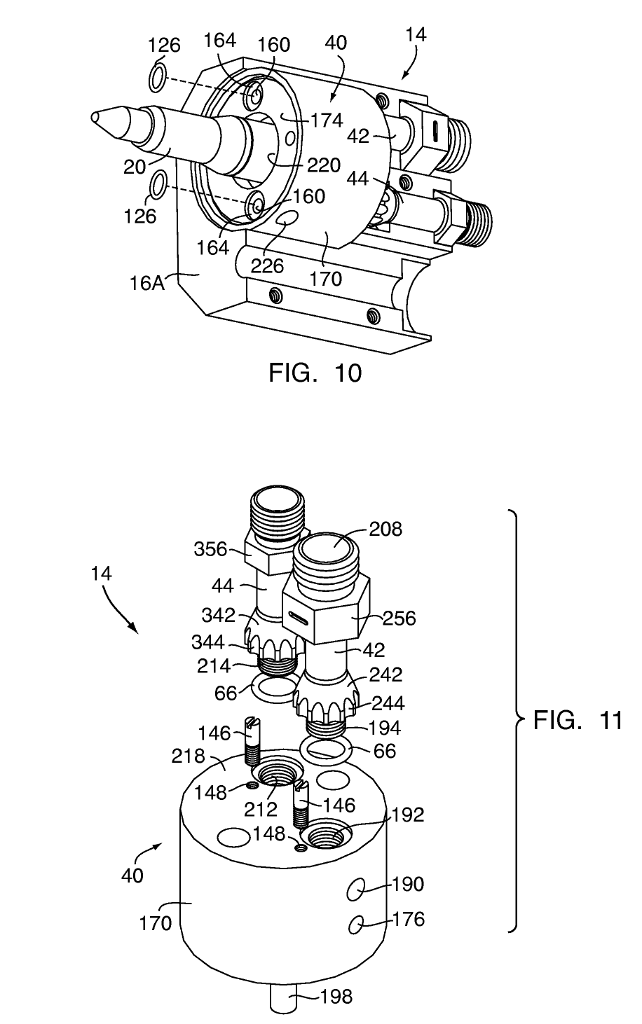

Referring to FIGS. 5 and 6, the first fluid opening 60 is in fluid communication with an inlet conduit 68 extending through the sidewall 46 to the central opening 48 of the sleeve 24. The sidewall 46 of the sleeve 24 defines an outlet 70 of the inlet conduit 68. The inlet conduit 68 is formed in part by a bore 72 extending through the water tube mount 58 generally perpendicular to the first fluid opening 60 and through the sidewall 46. An end of the bore 72 opposite the sidewall 46 is threaded for receiving a plug 74. In the FIG. 5 embodiment, the plug 74 is threadably installed in the bore 72 and tightened; thereafter, the end of the plug 74 is machined flush with a surface 76 of the water tube mount 58.

Still referring to FIGS. 5 and 6, the sidewall 46 of the sleeve 24 defines an annular flange 78 extending into the central opening 48 at a rear end 80 of the sleeve for engaging an end surface 82 of the core 26 when the core is fully inserted into the central opening 48 of the sleeve 24. The annular flange 78 establishes the lengthwise positioning of the core 26 relative to the sleeve 24.

An angular alignment element 83 establishes and fixes a predetermined angular alignment between the core 26 and sleeve 24 when assembled. In the embodiment shown in FIGS. 5 and 6, an alignment slot 84 defined by a forward end 86 of the sleeve 24 and the sidewall 46 receives a corresponding alignment tab 88 extending outwardly from an outer surface 90 of the forward end 92 of the core 26. Proper angular alignment between the core 26 and sleeve 24 is necessary to ensure alignment of the first electrode support member 12 and cooperating portions of the plasma spray gun 10.

Referring to FIG. 7, the core 26 is generally cylindrical in shape for removable insertion into the central opening 48 of the sleeve 24. The core 26 defines a stepped central bore 94 through a length Y thereof. An annular shoulder 96 extending throughout a rearward portion 98 of the core 26 is defined in part by the stepped central bore 94. A surface 100 of the shoulder 96 separates the rearward portion 98 from a forward portion 92 of the core 26. The forward portion 92 defines a cylindrical cavity 102 for receiving the electrode holder 28 therein, as shown in FIG. 4.

Referring to FIGS. 5-7, and 13, an outer surface 90 of the core 26 defines a circumferential coolant groove 104, which aligns with the outlet 70 of the inlet conduit 68 when the core 26 is inserted in the central opening 48 of the sleeve 24 and assembled therewith. Thus, coolant entering the first fluid opening 60 travels through the inlet conduit 68 and into the coolant groove 104 of the core 26. A seal groove 106 defined by the outer surface 90 on either side of the coolant groove 104 receives a seal 108 such as an O-ring in each of the seal grooves. The seals 108, 108 prevent coolant entering the coolant groove 104 from the inlet conduit 68 from passing into the area between the sleeve 24 and the core 26.

Referring to FIGS. 7 and 9, the rearward portion 98 of the core 26 defines a pair of inlet passageways 110 each having an inlet 112 in fluid communication with the coolant groove 104 at one end thereof and an outlet 114 at an opposing end opening through the surface 100 of the shoulder 96 into the cavity 102 in the forward portion 92 of the core. The inlet passageways 110 carry coolant delivered to the first electrode support member 12 via the first water tube 38 through the core 26 to a corresponding port 116 defined by the electrode holder 28 disposed in the cavity 102 of the forward portion 92 of the core, as shown in FIG. 9. Coolant for cooling an anode end of the spray gun including the core 26, the sleeve 24, the electrode holder 28, and nozzle 18 is delivered through the inlet passageways 110.

Referring to FIGS. 7 and 8, the rearward portion 98 of the core 26 also defines a pair of outlet passageways 118, 118 for carrying heated coolant from the electrode holder 28 through a length Z of the shoulder 96 to the rear section or second electrode support member 14 of the plasma spray gun 10. The outlet passageways 118, 118 each have an inlet port 120 defined by the end surface 82 of the core 26. Each outlet passageway 118, 118 has an outlet port 122 defined in part by the surface 100 of the shoulder 96 which are connectable with corresponding ports of the electrode holder 28. A seal seat 124 surrounding each of the inlet ports 120 is defined by the end surface 82 for receiving a seal 126 for fluidly sealing a connection between each of the outlet passageways 118, 118 and a mating component of the plasma spray gun 10, namely, the insulator section 22.

The end surface 82 also defines a plurality of threaded holes 128 for coupling the core 26 to the adjoining insulator section 22 and second electrode support member 14. Thus, the first electrode support member 12 couples at one end to the insulator section 22 that electrically separates the first electrode support member 12 from the second electrode support member 14, and, at an opposing end, to the electrode holder 28. As shown in FIG. 4, the end surface 82 further defines an annular seal groove 130 for receiving a seal 132 disposed between the end surface of the core 26 and a surface of the insulator section 22.

An edge 134 of the forward portion 92 of the core 26 defines an alignment opening 136 for establishing alignment of the electrode holder 28 relative to the core 26.

Referring back to FIG. 5, the first water tube 38 is manually detachable from the sleeve 24 at the first fluid opening 60 of the water tube mount 58. The first water tube 38 includes a one-piece structure having a threaded fitting at each end thereof. At an inlet end 138 of the first water tube 38, a threaded portion 140 is connectable to a coolant supply line (not shown) for receiving a coolant, such as water, to cool the plasma spray gun 10. A threaded outlet end 62 of the first water tube 38 connects to the first fluid opening 60 of the anode support member sleeve 24.

The first water tube 38 further defines a flared portion 142 near the outlet end 62 for strengthening the water tube near the connection with the coolant mount 58. The flared portion 142 defines a plurality of openings 144, preferably arcuate openings or slots, spaced about the circumference of the flared portion 142 for receiving a fastener 146 for securing the position of the first water tube 38 relative to the water tube mount 58. In accordance with the invention, the first water tube 38 is threadably coupled to the water tube mount 58 and tightened thereto with the O-ring 66 compressed therebetween. The water tube mount 58 further defines a threaded hole or bore 148 proximate to the first fluid opening 60 for receiving a threaded end of the fastener 146. In the illustrated embodiment, the fastener 146 is a setscrew, but could also be a bushing or the like. The threaded portion 62 at the outlet end of the first water tube 38 may, for example, define a ⅜″×24 thread such that each full rotation of the water tube causes a displacement of approximately 1/24″ or 0.041″ in the direction of the length of the water tube. Thus, rotation of the first water tube 38 through each of the twelve openings 144 spaced around the circumference of the first water tube 38 equates to the displacement of 0.041″ divided by 12, or approximately 0.0034″ displacement of the water tube in a direction of the length of the tube between each of the openings. Further, by way of example, the O-ring 66 is compressible approximately 0.020″ longitudinally and the corresponding O-ring seat 64 defines an overall depth of 0.005″ less than a standard O-ring seat. Collectively, the arrangement of the twelve openings 144, the threaded end 62 of the first water tube 38, the compressibility of the O-ring 66, and the reduced depth of the O-ring seat 64, ensure that the first water tube 38 is mountable to the sleeve 24 and the water tube mount 58 such that the O-ring 66 is compressible between the O-ring seat 64 and the first water tube 38 in accordance with the specifications of the O-ring to properly seal the joint between the first water tube 38 and the water tube mount 58 and further secure the water tube in place via the fastener 146. Accordingly, the first water tube 38 can easily be manually detached and re-installed or replaced separately from the other component parts of the plasma spray gun 10.

The fastener 146 includes a threaded end 150 engageable with the threaded hole or bore 148 defined by the water tube mount 58. Additionally, the fastener 146 defines a smooth shank 152 engageable with the surface of the openings 144 for securing the relative positions of the first water tube 38 and the water tube mount 58 including preventing the first water tube 38 from rotating relative to the water tube mount 58. The fastener 146 also includes a slotted head 154 for receiving the tip of a regular screwdriver. In the illustrated embodiment, the first water tube 38 is coupled to the water tube mount 58 via the threaded end 62 such that the O-ring 66 is compressed between the O-ring seat 64 and the water tube upon tightening of the water tube against the water tube mount. The inlet end 138 of the first water tube 38 defines a hexagon-shaped portion 156 such that a standard open end wrench can be use to tighten the first water tube 38 against the water tube mount 58.

In the disclosed embodiment, the first water tube 38 is secured in place by first rotating the first water tube 38 until metal-to-metal contact is made between the water tube mount 58 and the bottom of the flared portion 142, resulting in an over-compression of the O-ring 66 by 0.005″. The first water tube 38 is then backed out sufficiently to align the first-encountered opening 144 with the threaded hole or bore 148. As explained above, rotating the water tube 38 through one opening 144 relieves approximately 0.0034″ compression from the O-ring 66. However, the design allows the water tube 38 to be rotated up to two openings, or 0.0068″, without affecting the sealing capability of the O-ring 66. The fastener 146 is placed through the aligned opening 144 and threadably secured in the threaded hole or bore 148 via the threaded end 150 thereof. Thus, the openings 144, fastener 146 and threaded hole or bore 148 cooperate to provide a manually removable lock for preventing the detachment of the first water tube 38 from the sleeve 24 and water tube mount 58.

The hexagon-shaped portion 156 of the first water tube 38 can also be used to hold the inlet end 138 of the first water tube 38 stationary relative to a mating fitting on a coolant source line (not shown). In one embodiment, the first water tube 38 is formed of a metal such as brass for carrying a positive electric current to the anode of the plasma spray gun 10.

The first water tube 38 transports coolant such as water from a source to the anode end of the plasma spray gun 10. Typically, coolant water contained in a closed system is used for cooling the plasma spray gun 10 so that certain properties of the water can be closely controlled. For example, if even a small trace of lime is present in the coolant water, the first electrode 18 (e.g. the anode, or nozzle 18) and the second electrode 20 (e.g. the cathode) of the plasma spray gun 10 can be rapidly destroyed.

The sleeve 24, the core 26, and the first water tube 38 are each individual components of the first electrode support member 12 which can be easily separated for inspection, cleaning and replacement of one or more of the components apart from the others. For example, if the first water tube 38 is damaged during the dismantling of the plasma spray gun 10, only the water tube need be replaced as opposed to the entire center section of the prior art F4 plasma spray gun. Further, if the core 26 is worn or damaged, only the core need be replaced and is easily disassembled from the sleeve 24 for replacement thereof. If the sleeve 24 is damaged or worn or otherwise needs replacing, the sleeve is replaceable separately from the core 26 and the first water tube 38.

Additionally, the separable core 26 and sleeve 24 allow for the thorough cleaning of these parts during a maintenance process of the plasma spray gun 10. In prior art guns such as the F4 plasma spray gun, the center section is formed in one piece and cannot be dismantled for cleaning or partial replacement.

Preferably, the first electrode support member 12 includes the sleeve 24, core 26 and first water tube 38 configured such that each of these separable components is fabricated from a single piece of material such that there is no brazing or coupling of separate pieces to form these component parts of the anode support member. As such, the core 26, the sleeve 24, and the first water tube 38 of the first electrode support member 12 do not require any pressure testing of the coolant passageways following the machining thereof. The only testing required of the above-identified components of the present invention first electrode support member 12 includes measuring the parts to ensure conformance of the machined parts with any necessary manufacturing tolerances to provide functional components. This is a vast improvement over the prior art wherein the center section of an F4 spray gun is manufactured from a plurality of component parts brazed together to form fluid tight connections therebetween and wherein each center section must undergo multiple pressure tests following the manufacture of the part to confirm the integrity of the brazed joints between the multiple components thereof.

Accordingly, since there is no brazing involved and no pressure testing of brazed joints, the machined components of the present invention first electrode support member 12 including the core 26, the sleeve 24, and the first water tube 38 are less expensive to manufacture than the prior art center section of an F4 spray gun.

Referring back to FIG. 4, the first electrode support member 12 includes the electrode holder 28 for supporting the nozzle 18. As shown in FIG. 9, the electrode holder 28 defines coolant ports 116 for transporting coolant from the adjoining core 26 to the nozzle 18 and back through the electrode holder 28 to the core.

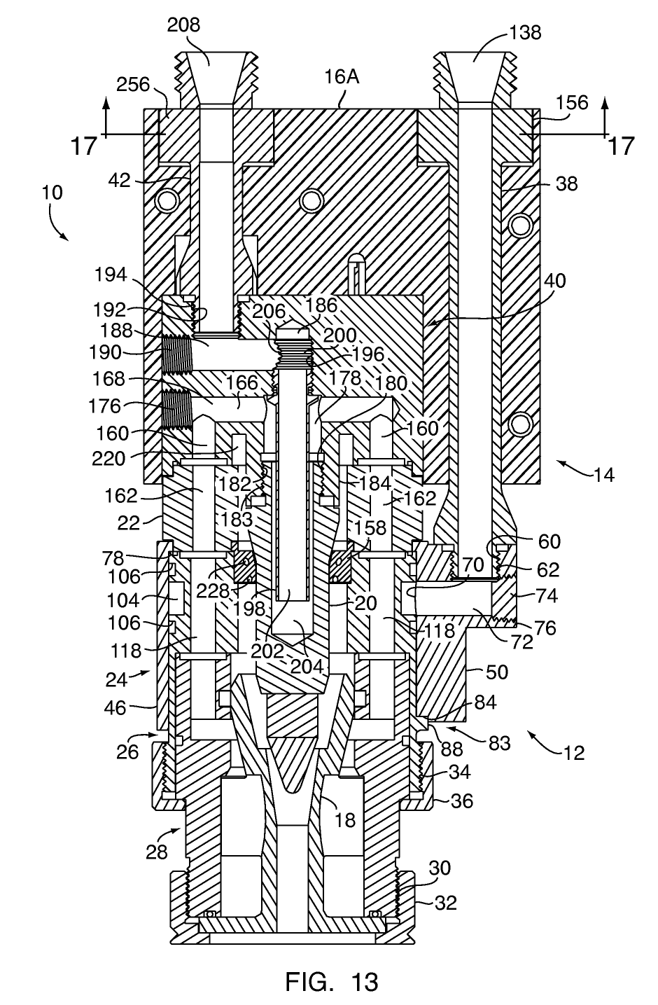

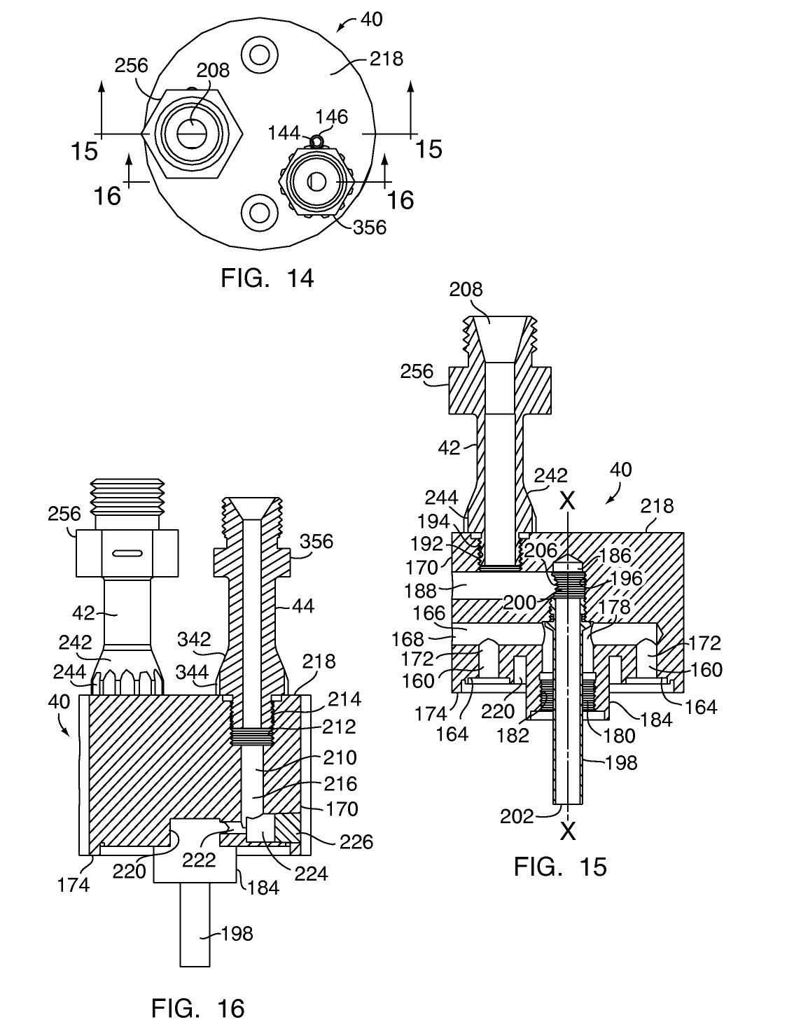

Referring to FIG. 13, the body portion 40 defines a pair of coolant inlet ports 160, 160 which align with corresponding coolant ports 162, 162 defined by the insulator section 22. The coolant ports 162, 162 of the insulator section 22 carry coolant from the outlet passageways 118, 118 of the core 26 of the first electrode support member 12 through the insulator section and to the body portion 40 of the second electrode support member 14. O-rings 126, 126 (shown in FIG. 4) are disposed between the insulator section 22 and a pair of O-ring seats 164, 164 (shown in FIG. 15) defined by the body portion 40 for sealing the coolant pathways between the insulator section and the body portion.

Referring to FIG. 15, the body portion 40 further defines an internal coolant conduit 166 disposed generally perpendicular to the X-X axis and the coolant inlet ports 160, 160, the internal coolant conduit 166 being in fluid communication with the both of the coolant inlet ports 160, 160. In the illustrated embodiment, the internal coolant conduit 166 is formed by drilling a blind-end bore 168 through a sidewall 170 of the body portion 40. A pair of drilled holes 172, 172 disposed in the body portion 40 intersects the blind-end bore 168 at one end, generally perpendicular thereto, and forms the coolant inlet ports 160, 160 at the opposing end. The coolant inlet ports 160, 160 each define inlets opening through an end surface 174 of the body portion. A plug 176 inserted in an open end of the bore 168 seals the end of bore and the coolant conduit 166, as shown in FIG. 13. Preferably, the plug 176 is machined flush with the sidewall 170 of the body portion following insertion thereof, as shown in FIG. 13.

Still referring to FIG. 15, the body portion 40 further defines a stepped central coolant port 178 which includes an inlet portion 180 having a threaded end 182 for receiving a corresponding threaded end piece 183 of the second electrode 20 (shown in FIG. 13). A boss 184 extends outwardly beyond the end surface 174 of the body portion; the boss partially defines the threaded end 182 of the inlet portion 180 of central coolant port 178. The coolant port 178 extends from the inlet portion 180 and intersects the internal coolant conduit 166 in fluid communication therewith. The central coolant port 178 further defines an outlet bore 186 centered about the X-axis and extending into the body portion 40 beyond the internal coolant conduit 166. The outlet bore 186 is a smaller diameter than that of the inlet portion 180. A coolant outlet conduit 188 formed as a blind-end bore extending through the sidewall 170 and extending into the body portion 40 generally perpendicular to the X-axis, intersects with the outlet bore 186. A plug 190 seals the open end of the coolant outlet conduit 188 after the drilling thereof. Preferably, the plug 190 is machined flush with the sidewall 170 of the body portion 40 following insertion thereof, as shown in FIG. 13.

Still referring to FIG. 15, the body portion 40 further defines a second fluid opening 192 extending generally parallel to the X-axis. In the disclosed embodiment, the second fluid opening 192 is a coolant outlet port. The second fluid opening 192 intersects and is in fluid communication with the coolant outlet conduit 188. The second fluid opening 192 defines a threaded portion at an outlet end thereof for receiving a threaded inlet end 194 of the second water tube 42.

Still referring to FIG. 15, the outlet bore 186 includes a threaded portion 196 in a middle section of the body portion 40 between the inlet portion 180 of the central coolant port 178 and the coolant outlet conduit 188. A cooling tube 198 defining a threaded end 200 is inserted in and threadably coupled to the threaded portion 196 of the outlet bore 186. An opposing open end 202 of the cooling tube 198 extends outwardly from the body portion 40 for insertion into the hollow interior 204 of the second electrode 20. The cooling tube 198 defines an opening 206 through the threaded end 200 thereof that is aligned with, and in fluid communication with the coolant outlet conduit 188 when the cooling tube 198 is threadably coupled to the body portion 40 via the outlet bore 186.

Referring to FIG. 13, in use of the second electrode support member 14 with the plasma spray gun 10, coolant exiting from the first electrode support member 12 enters the body portion 40 via the coolant inlet ports 160, 160 and through the internal coolant conduit 166 into the central coolant port 178. From the central coolant port 178, the coolant enters the hollow interior 204 of the second electrode 20 for cooling the electrode. The coolant then exits the second electrode 20 through the cooling tube 198 and into the coolant outlet conduit 188 via the opening 206, travels through the coolant outlet conduit 188 and exits the body portion 40 via the second fluid opening 192 and the second water tube 42. Thus, the first and second water tubes 38, 42 serve to circulate coolant through the plasma spray gun assembly. A coolant return line (not shown) is connectable to the outlet end 208 of the second water tube 42 for transporting heated coolant away from the plasma spray gun 10. The second water tube 42 is typically formed of a metal such as brass for carrying a negative electric current to the electrode of the plasma spray gun 10.

Referring to FIG. 11, the second water tube 42 defines a flared portion 242 near the inlet end 194 for strengthening the water tube near the connection with the body portion 40. As set forth above with respect to the first water tube 38, the flared portion 242 of the second water tube 42 also defines a plurality of openings 244 spaced about the circumference of the flared portion 242 for receiving a fastener 146 for securing the position of the second water tube 42 relative to the body portion 40. Preferably, the openings 244 are arcuate openings or slots. As set forth above with respect to the first water tube 38, the second water tube 42 is threadably coupled to the body portion 40 and tightened thereto with an O-ring 66 compressed therebetween. The body portion 40 further defines the threaded hole or bore 148 proximate to the second fluid opening 192 for receiving a threaded end of the fastener 146. The second water tube 42 can be manually detached from the body portion 40 at the second fluid opening 192 and re-installed or replaced and securely coupled to the body portion via the O-ring 66, the threaded end 194 of the coolant outlet tube and the fastener 146. The openings 244, fastener 146 and threaded hole or bore 148 cooperate to provide a manually removable lock for preventing the detachment of the second water tube 42 from the body portion 40.

The second water tube 42 further defines a hexagon-shaped portion 256 near the outlet end 208 thereof such that a standard open-end wrench can be use to tighten the coolant outlet tube against the body portion 40 and the O-ring 66. Additionally, the hexagon-shaped portion 256 can be utilized in coupling the second water tube 42 to a coolant return line (not shown).

Referring to FIG. 16, the body portion 40 also defines gas passageways for carrying plasma gas through the body portion of the plasma spray gun 10. The gas passageways include a third fluid opening 210. In the disclosed embodiment, the third fluid opening 210 is a plasma gas inlet port. The third fluid opening 210 has a threaded gas inlet 212 for receiving a threaded outlet end 214 of the gas inlet tube 44. Preferably, the body portion 40 defines different thread sizes, either pitch or diameter, or both, for the gas inlet 212 and the second fluid opening 192 to avoid confusion therebetween and/or the improper installation of the gas inlet tube 44 or the second water tube 42. In one example, the thread size is 3/8-32. In the illustrated embodiment, the third fluid opening 210 is defined by a blind bore 216 extending generally parallel to the X-axis from a rear surface 218 of the body portion into the body portion 40. The body portion 40 further defines an annular gas opening 220 surrounding a portion of the boss 184 and extending inwardly towards a center of the body portion from the end surface 174 of body portion 40. The annular gas opening 220 is in fluid communication with the third fluid opening 210 via an inlet port extension 222 defined by the body portion 40 and extending to the third fluid opening 210. The inlet port extension 222 is formed via a bore 224 extending through the cylindrical sidewall 170 of the body portion 40 and opening into the annular gas opening 220. The third fluid opening 210 intersects the inlet port extension 222 and is in fluid communication therewith. A plug 226 is disposed in the open end of the bore 224 to seal the end thereof. Typically, an outer end of the plug 226 is machined following insertion thereof such that the plug is flush with the sidewall 170 of the body portion. As shown in FIG. 13, the annular gas opening 220 is in fluid communication with a plurality of gas openings 228 defined by a gas distribution ring 158 such that the plasma gas passing through the annular gas opening is delivered through the gas openings in the gas distribution ring and dispersed about the circumference of the second electrode 20 towards the nozzle 18 of the plasma spray gun 10.

Referring to FIG. 11, the gas inlet tube 44 defines a flared portion 342 near the outlet end 214 for strengthening the water tube near the connection with the body portion 40. As set forth above with respect to the first water tube 38, the flared portion 342 of the gas inlet tube 44 also defines a plurality of openings 344 spaced about the circumference of the flared portion 342 for receiving the fastener 146 for securing the position of the gas inlet tube 44 relative to the body portion 40. As set forth above with respect to the first water tube 38, the gas inlet tube 44 is threadably coupled to the body portion 40 and tightened thereto with an O-ring 66 compressed therebetween. The body portion 40 further defines the threaded hole or bore 148 proximate to the gas inlet 212 for receiving a threaded end of the fastener 146. The gas inlet tube 44 can be manually detached from the body portion 40 at the third fluid opening 210 and re-installed or replaced and securely coupled to the body portion via the O-ring 66, the threaded end 214 of the gas inlet tube and the fastener 146. The openings 344, fastener 146 and threaded hole or bore 148 cooperate to provide a manually removable lock for preventing the detachment of the gas inlet tube 44 from the body portion 40.

The gas inlet tube 44 further defines a hexagon-shaped portion 356 near an inlet end thereof such that a standard open-end wrench can be use to tighten the gas inlet tube against the body portion 40 and the O-ring 66. Additionally, the hexagon-shaped portion 356 can be utilized in coupling the gas inlet tube 44 to a gas source line (not shown). In one example, the hexagon-shaped portion 356 is a different size than the hexagon-shaped portion 156, 256 of the first and second water tube 38, 42 respectively. The differing hex size aids in preventing improper assembly of the plasma spray gun 10 should the first or second water tube 38, 42 respectively, be inadvertently installed into the opening for the gas inlet 212, as will be explained below.

Referring to FIG. 4, the housing 16 includes two half sections 16A and 16B which cooperate to encase substantially the second electrode support member 14 including the second water tube 42 and the gas inlet tube 44 as well as the first water tube 38. Typically, the housing half sections 16A, 16B are formed of a nonconductor such as plastic and define separate cavities 258, 260 for receiving each of the first water tube 38 and the second water tube 42 respectively so that each of these electrical conductors, positive and negative, respectively are separately encased in the housing half sections 16A, 16B so as to prevent a short circuit therebetween. Additionally, the housing half sections 16A and 16B define additional cavities 262, 264 for encasing each of the body portion 40 of the second electrode support member 14 and the gas inlet tube 44 respectively. The housing half section 16A defines threaded holes for receiving fasteners for coupling the half sections 16A and 16B together around the above-identified component parts of the plasma spray gun 10.

The housing half sections 16A and 16B further define cavities 270, 266, and 268 for the hexagon-shaped portion 156, 256, and 356 of the first water tube 38, the second water tube 42, and the gas inlet tube 44 respectively. At least one of the cavities 270, 266, and 268 is a different size relative to the others to prevent incorrect assembly of the plasma spray gun 10. In the illustrated example, cavity 268 is smaller than cavity 266 and 270, such that it will not accept the larger hexagon-shaped portion 156 and 256. Accordingly, the housing half sections 16A and 16B will not assemble properly if either the first or second water tube 42 and 44, respectively, is inadvertently installed into the opening for the gas inlet 212.

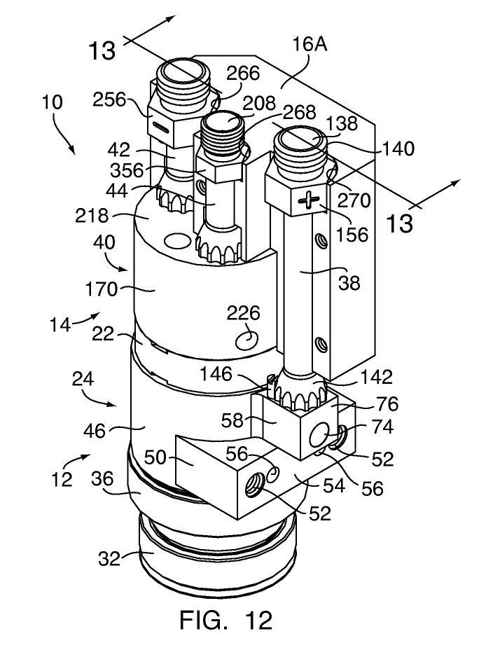

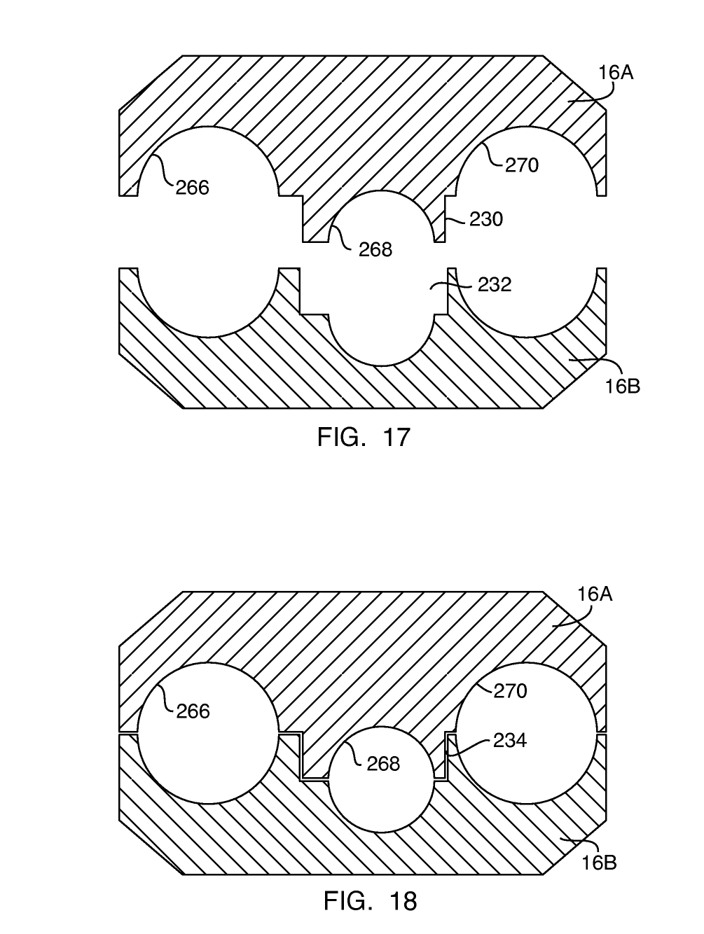

Referring to FIG. 17, the housing half sections 16A and 16B shown in spaced apart relationship are not flat at the parting plane. Rather, the housing half section 16A defines a protrusion 230 to engage a corresponding recess 232 formed in the housing half section 16B, thereby creating an interlocking, male/female relational fit. Referring to FIG. 18, the two half sections 16A and 16B are shown assembled. A small gap 234 between the half sections may remain after the assembly process. In the prior art guns the resulting gap 234 can accumulate electrically conductive plasma spray powder and develop a short circuit between the positively charged first water tube 38 and the negatively charged second water tube 42 shown in FIG. 12. With the improved half sections 16A, 16B, the protrusion 230 and the recess 232 interfere with the accumulation of plasma spray powder, and correspondingly the development of a short circuit.

In use, the plasma spray gun 10 provides a thermal plasma to melt and deposit powders of virtually any metal alloy or refractory ceramic, as well as combinations of materials on a substrate or other surface. As shown in FIG. 4, powder is fed into the plasma flame through injectors 45 mounted near the nozzle 18 exit opening. Typically, the plasma spray gun 10 includes an anode nozzle 18 formed of copper and a cathode (second electrode 20) formed of tungsten, both of which are water cooled as set forth above.

The foregoing description of embodiments of the present invention have been presented for the purpose of illustration and description and are not intended to be exhaustive or to limit the invention to the form disclosed. Obvious modifications and variations are possible in light of the above disclosure. The embodiments described were chosen to best illustrate the principals of the invention and practical applications thereof to enable one of ordinary skill in the art to utilize the invention in various embodiments and with various modifications as suited to the particular use contemplated. It is intended that the scope of the invention be defined by the claims appended hereto.

What is claimed is:

1. A modular plasma spray gun assembly comprising:
a first electrode support member having a first fluid opening disposed therein;
a second electrode support member coupled to the first electrode support member, the second electrode support member having a body portion, the body portion having a second fluid opening and a third fluid opening disposed therein;
an insulator disposed between the first electrode support member and the second electrode support member;
an electrode holder secured within the first electrode support member;
a nozzle coupled to and supported by the electrode holder, the nozzle serving as a first electrode of the plasma spray gun assembly;
a second, oppositely charged electrode coupled to and supported by the second electrode support member;
a first coolant tube secured to the first fluid opening of the first electrode support member;
a second coolant tube secured to the second fluid opening of the second electrode support member, the first and second coolant tubes serving to circulate a coolant through the plasma spray gun assembly; and
a gas inlet tube secured to the third fluid opening of the second electrode support member;
wherein at least one of the coolant and gas tubes is manually detachable from the respective fluid opening.

2. The plasma spray gun assembly according to claim 1 wherein the first electrode support member further comprises a core and a sleeve aligned with one another about an axis, the core being separable from the sleeve.

3. The plasma spray gun assembly according to claim 2 wherein the core and the sleeve have an angular alignment element so as to establish and fix a predetermined angular alignment about the axis.

4. The plasma spray gun assembly according to claim 3 wherein the angular alignment element includes the sleeve defining an alignment slot for receiving a corresponding alignment tab coupled to the core.

5. The plasma spray gun assembly according to claim 1 further comprising a housing removably coupled to the second electrode support member, the housing defining a cavity for receiving at least one of the coolant and gas tubes and the body portion of the second electrode support member.

6. The plasma spray gun assembly according to claim 5, the housing defining a plurality of cavities for receiving the first and second coolant tubes, the gas inlet tube, and the body portion of the second electrode support member.

7. The plasma spray gun assembly according to claim 1 further comprising a manually removable lock configured in a secured position to prevent the detachment of the at least one of the coolant and gas tubes from the respective fluid opening.

8. The plasma spray gun assembly according to claim 7 wherein the at least one of the coolant and gas tubes has a rotatable connection with the electrode support member having the fluid opening from which the at least one tube is detachable, the electrode support member defining the fluid opening from which the at least one tube is detachable also having a bore proximate to the respective fluid opening, the manually removable lock comprising:
an opening disposed on the at least one tube, the opening being aligned with the bore in the secured position; and
a fastener secured in the bore and the opening.

9. The plasma spray gun assembly according to claim 8 wherein the rotatable connection is a threaded connection.

10. The plasma spray gun assembly according to claim 9 wherein the body portion of the second electrode support member defines threaded connections for the second and third fluid openings, the threaded connections having different thread sizes.

11. The plasma spray gun assembly according to claim 1 wherein the first electrode is the anode and the second electrode is the cathode.

12. A modular plasma spray gun assembly comprising:
an anode support member having a first fluid opening disposed therein;
a cathode support member coupled to the anode support member, the cathode support member comprising a body portion, the body portion having a second fluid opening and a third fluid opening disposed therein;
an insulator disposed between the anode support member and the cathode support member;
an anode holder secured within the anode support member;
a nozzle coupled to and supported by the anode holder, the nozzle serving as an anode of the plasma spray gun assembly;
an electrode coupled to and supported by the cathode support member, the electrode serving as a cathode of the plasma spray gun assembly;
a coolant inlet tube secured to the first fluid opening of the anode support member;
a coolant outlet tube secured to the second fluid opening of the cathode support member, the coolant inlet and coolant outlet tubes serving to circulate a coolant through the plasma spray gun assembly; and
a gas inlet tube secured to the third fluid opening of the cathode support member;
wherein at least one of the coolant inlet tube, the coolant outlet tube, and the gas inlet tube is manually detachable from the respective fluid opening.

13. A modular anode support member for use with a plasma spray gun comprising:
a sleeve having a cylindrical sidewall defining a central opening through a length of the sleeve along an axis thereto, a mounting member extending outwardly from an outer surface of the sidewall, the mounting member for mounting the sleeve to an associated spray gun or a spray gun manipulator, a coolant tube mount extending outwardly from the sidewall, the coolant tube mount defining a coolant inlet in fluid communication with an inlet conduit extending through the sidewall to the central opening;
a core aligned with the sleeve about the axis, the core being separable from the central opening of the sleeve along the axis thereof, the core having a forward end and a rearward portion defined by a stepped central bore through a length thereof, an annular shoulder defined by the stepped central bore extending through the rearward portion, an outer surface of the rearward portion defining a circumferential coolant groove aligned with the inlet conduit of the sleeve, the forward end for receiving an anode holder therein, the rearward portion defining an inlet passageway and an outlet passageway for carrying coolant to and from the anode holder, the inlet passageway in fluid communication with the coolant groove;
an angular alignment element for establishing and fixing a predetermined angular alignment of the core relative to the sleeve about the axis; and
at least one seal disposed between the core and the sleeve adjacent the coolant groove for fluidly sealing the inlet conduit and the coolant groove;
wherein the core and the sleeve are configured to provide a separable, cooled anode support member of the plasma spray gun.

14. The modular anode support member according to claim 13 wherein the sidewall of the sleeve further defines a flange extending into the central opening and engaging an end surface of the rearward portion of the core for lengthwise positioning of the core relative to the sleeve, the end surface opposing the surface of the shoulder.

15. The modular anode support member according to claim 13 wherein the coolant inlet includes a threaded portion for receiving an end of a coolant tube.

16. The modular anode support member according to claim 13 further comprising a coolant tube manually detachable from the coolant tube mount.

17. The modular anode support member according to claim 16 wherein the coolant tube includes a one-piece structure having a threaded fitting formed on at least one end thereof.

18. The modular anode support member according to claim 16 further comprising a manually removable lock configured in a secured position to prevent the detachment of the coolant tube from the coolant tube mount.

19. The modular anode support member according to claim 13 wherein the angular alignment element includes the sleeve defining an alignment slot for receiving a corresponding alignment tab coupled to the core.

20. The modular anode support member according to claim 13 wherein the angular alignment element includes at least one alignment tab extending outwardly from an outer surface of the core.

21. A modular cathode support member for use with a plasma spray gun comprising:
a body portion for carrying an electrode of the plasma spray gun;
a coolant outlet tube coupled to the body portion at a first end thereof and connectable to a coolant return line at a second end thereof, the coolant outlet tube for carrying an electric current to the electrode; and
a gas inlet tube coupled to the body portion at a first end thereof and connectable to a gas source line at a second end thereof;
the body portion defining internal conduits for transporting coolant from an anode support member of the plasma spray gun through the electrode and to the coolant outlet tube, the body portion further defining a passageway for transporting gas from the gas inlet tube through the body portion for distribution around the electrode, and
wherein each of the coolant outlet tube and gas inlet tube are manually detachable from the body portion for separate replacement thereof.

22. The modular cathode support member according to claim 21 further comprising a manually removable lock to prevent the detachment of at least one of the coolant outlet tube and the gas inlet tube from the body portion.

23. The modular cathode support member according to claim 21 wherein the body portion is fabricated from a single piece of material.

24. The modular cathode support member according to claim 21 wherein the coolant outlet tube includes a fitting on at least one end thereof for coupling the coolant outlet tube to the body portion or a coolant return line.

25. The modular cathode support member according to claim 24 wherein the coolant outlet tube including the fitting are fabricated from a single piece of material.

26. The modular cathode support member according to claim 21 wherein each of the coolant outlet tube and gas inlet tube are threadably attachable and detachable from the body portion.

27. The modular cathode support member according to claim 26 wherein the gas inlet tube has a thread size different from the thread size of the coolant outlet tube.

28. The modular cathode support member according to claim 21 wherein each of the coolant outlet tube and gas inlet tube have a hexagon-shaped portion, the hexagon-shaped portion of the coolant outlet tube being a different size than the hexagon-shaped portion of the gas inlet tube.

29. A modular plasma spray gun assembly comprising:
a first electrode support member having a first fluid opening disposed therein;
a second electrode support member coupled to the first electrode support member, the second electrode support member having a body portion, the body portion having a second fluid opening and a third fluid opening disposed therein;
an insulator disposed between the first electrode support member and the second electrode support member;
an electrode holder secured within the first electrode support member;
a nozzle coupled to and supported by the electrode holder, the nozzle serving as a first electrode of the plasma spray gun assembly;
a second, oppositely charged electrode coupled to and supported by the second electrode support member;
a first coolant tube secured to the first fluid opening of the first electrode support member;
a second coolant tube secured to the second fluid opening of the second electrode support member, the first and second coolant tubes serving to circulate a coolant through the plasma spray gun assembly; and
a gas inlet tube secured to the third fluid opening of the second electrode support member; and
an interlocking modular housing removably coupled to the second electrode support member, a first portion of the housing defining a protrusion to engage a recess formed in a second portion of the housing.

30. The plasma spray gun assembly according to claim 29, the housing further defining a cavity formed within the protrusion and the recess for receiving at least one of the coolant and gas tubes.
